(19) United States
(12) Patent Application Publication
(10) Pub. No.: US 2024/0314838 A1
(43) Pub. Date: Sep. 19, 2024

(54) Access Point, Communication Controlling Method, and Non-Transitory Computer-Readable Recording Medium

(71) Applicant: Yamaha Corporation, Hamamatsu-shi (JP)

(72) Inventors: Akihisa ONODA, Hamamatsu (JP); Hirokazu SUZUKI, Yokohama (JP); Tomohiro SHINKAWA, Hamamatsu (JP)

(21) Appl. No.: 18/606,057

(22) Filed: Mar. 15, 2024

(30) Foreign Application Priority Data
Mar. 17, 2023 (JP) 2023-043487

(51) Int. Cl. H04W 74/0808; H04W 72/56

(52) U.S. Cl. CPC H04W 74/0808; H04W 72/56

(57) ABSTRACT

An access point includes a first communicator, a detector, and a controller. The first communicator wirelessly communicates with a communication terminal using a first channel among a plurality of channels. The detector detects a priority signal. The controller checks the plurality of channels to set a second channel from among the plurality of channels. The second channel is different from the first channel and satisfies a first condition. The controller instructs the detector to monitor the second channel for the priority signal. In a case where the first communicator has detected the priority signal in the first channel, the controller switches the first channel to the second channel.

### CROSS-REFERENCE TO RELATED APPLICATIONS

The present application claims priority under 35 U.S.C. § 119 to Japanese Patent Application No. JP2023-043487, filed Mar. 17, 2023. The contents of this application are incorporated herein by reference in their entirety.

### BACKGROUND

The present disclosure relates to an access point, a communication controlling method, and a non-transitory computer-readable recording medium.

In wireless communication networks such as wireless local area network (LAN), frequency bands of 2.4 GHz, 5 GHZ, and 6 GHz are used. In the 5 GHz frequency range, the frequency bands designated as W53 and W56 must be utilized with a function to prevent interference with military and meteorological radar systems. This function is referred to as DFS (Dynamic Frequency Selection). DFS functions as follows. First, to initiate wireless communication on a channel designated as W53/W56, it is necessary to verify in advance that no particular radar signal (hereinafter referred to as simply “radar signal” or “priority signal”) has been detected for a duration of one minute. This processing is referred to as CAC (Channel Availability Check). In a case where a CAC detects a radar signal on a channel, the use of the channel must be suspended for 30 minutes to prioritize the radar signal. If a radar signal is detected on a channel, common practice is to switch to a different channel and resume wireless communication on the different channel. Even on the different channel, however, wireless communication can not be initiated for a duration of one minute after detecting a radar signal, even if the radar signal is not used on the different channel. A state in which wireless communication is taking place is referred to as ISM (In-Service Monitoring).

In order to shorten the duration of wireless communication unavailability, JP 2010-278825 A discloses the use of a radar signal detection module in addition to a terminal communication module. Specifically, the radar signal detection module performs in advance a CAC for a channel different from the channel used by the terminal communication module. If a radar signal is detected in the channel currently used for wireless communication, the current channel is switched to the CAC-target channel, in an attempt to shorten the duration of wireless communication unavailability.

Even if a radar signal detection module is used, however, wireless communication can not take place for the time spent in switching between channels. Additionally, efficiency considerations arise as the radar signal detection module can not be used for terminal communication purposes.

An object of the present disclosure is to more efficiently provide a configuration that shortens the duration of wireless communication unavailability.

### SUMMARY

One aspect is an access point that includes a first communicator, a detector, and a controller. The first communicator is configured to wirelessly communicate with a communication terminal using a first channel among a plurality of channels. The detector is configured to detect a priority signal. The controller is configured to check the plurality of channels to set a second channel from among the plurality of channels. The second channel is different from the first channel and satisfies a first condition. The controller is configured to instruct the detector to monitor the second channel for the priority signal. In a case where the first communicator has detected the priority signal in the first channel, the controller is configured to switch the first channel to the second channel.

Another aspect is a computer-implemented communication controlling method that includes checking a plurality of channels to set a second channel, from among the plurality of channels, that satisfies a first condition and that is different from a first channel, among the plurality of channels, that is being used for wireless communication between a communication terminal and a first communicator. The method also includes instructing a detector to monitor the second channel for a priority signal. The method also includes, in a case where the first communicator has detected the priority signal in the first channel, switching the first channel to the second channel.

Another aspect is a non-transitory computer-readable recording medium that stores a program. When the program is executed by at least one computer, the program causes the at least one computer to perform a method that includes checking a plurality of channels to set a second channel, from among the plurality of channels, that satisfies a first condition and that is different from a first channel, among the plurality of channels, that is being used for wireless communication between a communication terminal and a first communicator. The method also includes instructing a detector to monitor the second channel for a priority signal. The method also includes, in a case where the first communicator has detected the priority signal in the first channel, switching the first channel to the second channel.

The above-described aspects more efficiently provide a configuration that shortens the duration of wireless communication unavailability.

A more complete appreciation of the present disclosure and many of the attendant advantages thereof will be readily obtained as the same becomes better understood by reference to the following detailed description when considered in connection with the following figures, in which:

### BRIEF DESCRIPTION OF THE DRAWINGS

FIG. 1 is a diagram illustrating a configuration of a communication system;

FIG. 2 is a flowchart of communication control processing;

FIG. 3 is a flowchart of the communication control processing;

FIG. 4 is a schematic illustration of a checking result data table;

FIG. 5 is a flowchart of the communication control processing;

FIG. 6 is a flowchart of communication control processing;

FIG. 7 is a flowchart of communication control processing;

FIG. 8 is a flowchart of communication control processing;

FIG. 9 is a flowchart of communication control processing; and

FIG. 10 is a diagram illustrating a configuration of a communication system.

### DETAILED DESCRIPTION

The present specification is applicable to an access point, a communication controlling method, and a non-transitory computer-readable recording medium.

The embodiments will now be described with reference to the accompanying drawings, wherein like reference numerals designate corresponding or identical elements throughout the various drawings. The embodiments presented below serve as illustrative examples of the present disclosure and are not intended to limit the scope of the present disclosure. In the accompanying drawings referenced in the embodiments, similar reference numerals, characters, or symbols may be used to indicate corresponding or identical elements. For example, to distinguish like elements, “A” may be appended to a reference numeral and “B” may be appended to the same reference numeral.

A communication system 1 according to an embodiment is implemented by an access point that the relays wireless communication. This access point is a communication device that establishes wireless communication using a frequency band at least in the 5 GHz frequency range and that is capable of performing processing equivalent to a DFS. By the method described below, the access point more efficiently provides a configuration that shortens the duration of wireless communication unavailability. The access point according to the embodiment will be described below. It is to be noted that the communication system 1 may be implemented by any other communication device such as a router and a network switch, instead of an access point.

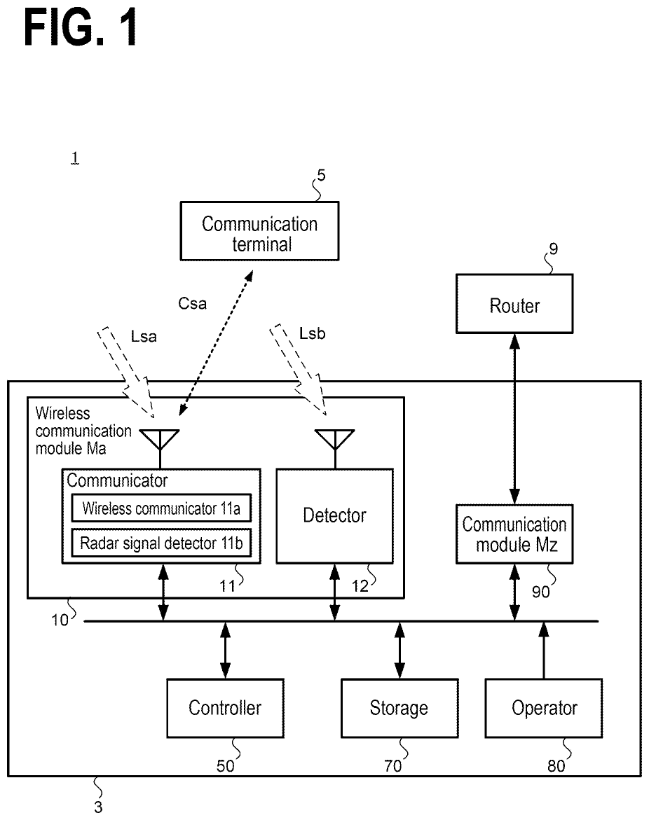

FIG. 1 is a diagram illustrating a configuration of the communication system 1 according to the embodiment of the present disclosure. An access point 3 is a device that provides a wireless LAN environment to a communication terminal 5. Specifically, the access point 3 serves as a relay to connect the communication terminal 5 to a WAN (such as the Internet) via a router 9. It is to be noted that while in FIG. 1 a single communication terminal 5 is illustrated, there may be a plurality of communication terminals 5.

The access point 3 includes a wireless communication module Ma 10, a controller 50, a storage 70, an operator 80, and a communication module Mz 90. These elements are connected to each other via a bus. In the embodiment, the communication system 1 includes the wireless communication module Ma 10 and the controller 50. The wireless communication module Ma 10 and the controller 50 are contained in a single enclosure to form a part of the access point 3.

The wireless communication module Ma 10 includes a communicator 11 (also referred to as first communicator) and a detector 12. The wireless communication module may be configured in the form of a single chipset. The communicator 11 includes a wireless communicator 11a and a radar signal detector 11b. The controller 50 sets, in the communicator 11, a channel from among channels in the 5 GHz frequency range. The wireless communicator 11a uses the channel set by the controller 50 to establish wireless communication Csa with the communication terminal 5. The radar signal detector 11b uses the same channel to detect a radar signal Lsa (also referred to as priority signal). The channel set in the communicator 11 (this channel will also be referred to as first channel) is selected from the channels included in types W53 and W56 according to the IEEE 802.11 standards. It is to be noted that a channel not targeted for radar signal detection purposes may be set in the communicator 11. Examples of such channel include a channel included in type W52, a channel in the 2.4 HGz range, and a channel in the 6 GHz frequency range.

The detector 12 detects a radar signal Lsb. It is to be noted that the radar signal Lsa (which is detected by the communicator 11) and the radar signal Lsb (which is detected by the detector 12) are thus denoted differently to distinguish wireless communication modules detectable by different channels. The radar signals, Lsa and Lsb, may be collectively referred to as radar signal Ls in a description applicable to both Lsa and Lsb. This designation is used when there is no need to differentiate between detectable wireless communication modules.

The detector 12 also performs processing of analyzing data received at each channel. In this example, the detector 12 analyzes a beacon signal received at each channel to check the number of other access points existing around the access point 3, the signal strength (also referred to as RSSI) of the obtained beacon signal, and the amount of noise in the beacon signal.

The communication module Mz 90 according to the embodiment has a function to serve as a communicator that communicates with the router 9 to communicate with another device via the router 9. This communication may be wireless communication using the 2.4 GHz band or may be wired communication.

The storage 70 stores control programs executed by the controller 50 and stores information such as various tables. The storage 70 is stored in, for example, a detection device, described later, and updated by the controller 50 at a timing determined by the controller 50. The operator 80 includes operation pieces such as a power source button and a setting button, receives a user's operation on the operation pieces, and outputs a signal based on the operation to the controller 50.

The controller 50 includes a memory and an arithmetic processing circuit such as CPU. The controller 50, at CPU, executes the control programs stored in the storage 70 to cause the access point 3 to implement various functions. The functions implemented include a communication control function. This communication control function enables communication control processing, described later, to be performed.

It suffices that each control program is a computer-executable program. Specifically, each control program may be provided in the form of a computer readable recording medium such as a magnetic recording medium, an optical recording medium, a magneto-optical recording medium, and a semiconductor such as a memory. In this case, the access point 3 may include a device to read the recording medium. The control program may be downloaded via a wireless communication module. 1-3. Communication Control Processing

The communication control processing (communication controlling method) will be described.

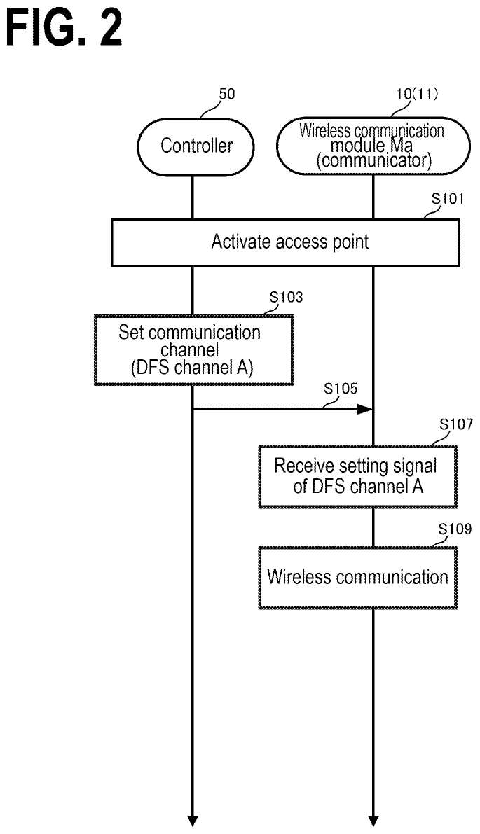

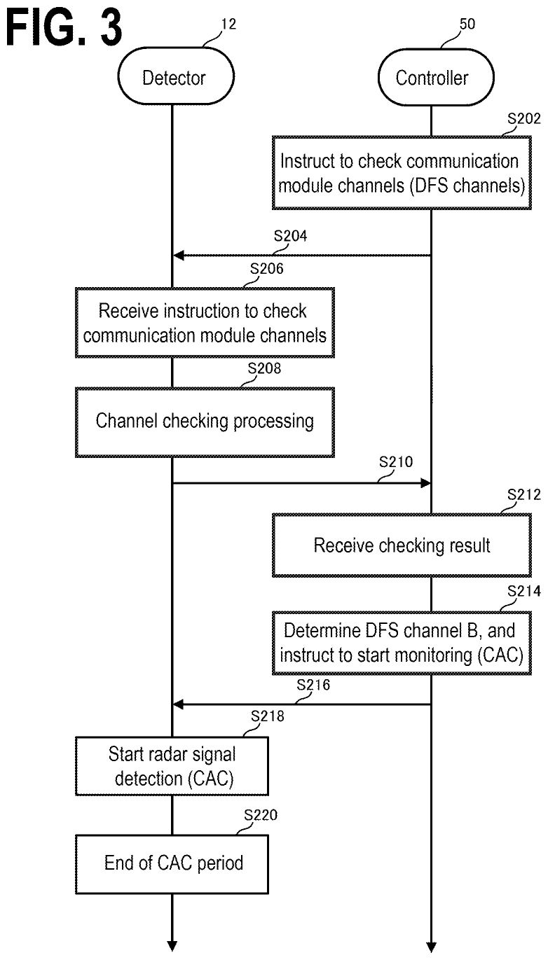

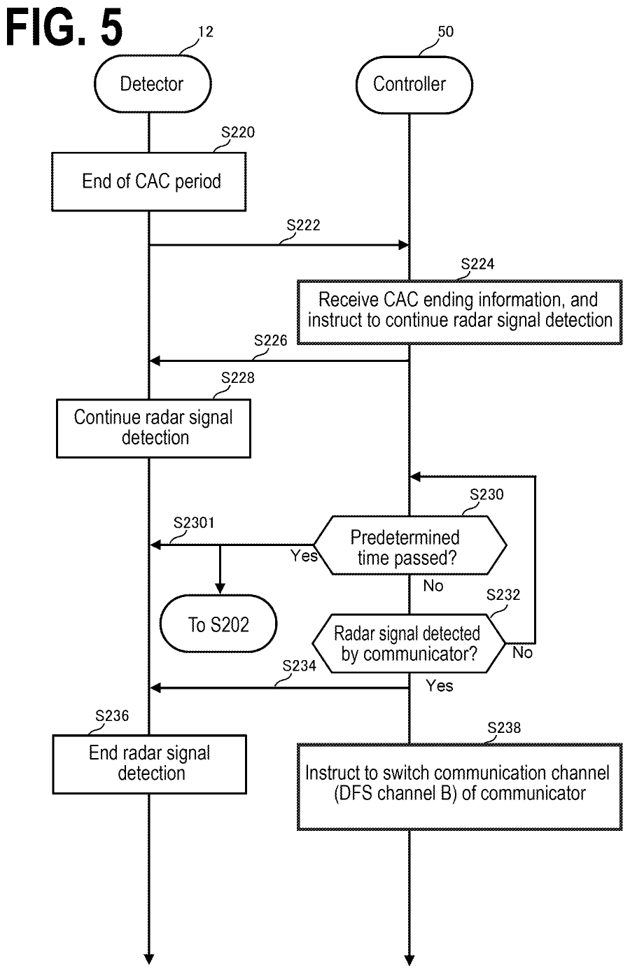

FIGS. 2, 3, and 5 are flowcharts of the communication control processing according to the embodiment. The communication control processing starts by turning on a power source of the access point 3 to activate the access point 3 (step S101). The communication control processing may also start at a user's demand (start setting) to start the communication control processing.

Upon activation of the access point 3, the controller 50 first sets a communication channel (also referred to as “first channel”) used by the wireless communication module Ma 10 (step S103). As illustrated in FIG. 2, a DFS-available communication channel (DFS channel A) is set as the communication channel. The channel to be set may be a predetermined channel, may be the channel already set at the time of previous power off, or may be determined based on a history such as channel usage frequency.

According to the state-of-the-art standard, a channel in which a radar signal Ls has been detected is restricted and unavailable for a duration of 30 minutes. In light of this standard, in a case where this standard applies and a radar signal Ls has been detected in the channel used by the wireless communication module Ma 10, the controller 50 controls this channel to be unavailable in any wireless communication module M for 30 minutes after the detection of the radar signal Ls.

The controller 50 transmits a setting signal of the communication channel (DFS channel A) to the wireless communication module 10 (step S105). Upon receipt of the setting signal of the communication channel at the wireless communication module 10 (step S107), a communicator Ma 11 of the wireless communication module 10 wirelessly communicates with the communication terminal 5 (step S109).

Next, the controller 50 instructs the detector 12 to check all channels, among the communication channels capable of detecting a radar signal, that are currently not used by the communicator 11 (step S202). In other words, the controller 50 transmits a checking instruction signal to the detector 12 of the wireless communication module 10. Upon receipt of the checking instruction signal (step S206), the detector 12 performs checking processing on the above-described all communication channels (step S208). Specifically, the detector 12 receives wireless communication data (specifically, an IEEE 802.11-compliant beacon signal) associated with each checking target channel. Then, the detector 12 analyzes the received communication data to check: the number of other access points (also referred to as “second access points”) connected to each checking target channel existing around the access point 3; the signal strength (also referred to as “RSSI”) of the obtained beacon signal; and the amount of noise in the beacon signal. The detector 12 repeats this checking processing for all the DFS-available communication channels excluding the channel used by the communicator 11 of the wireless communication module 10. The detector 12 transmits a result of this check (checking result, checking data) to the controller 50 (step S210).

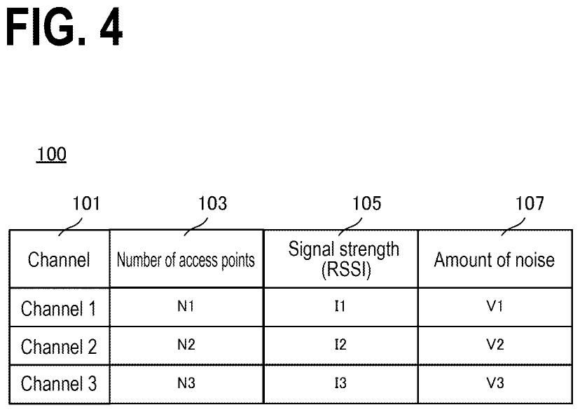

The controller 50 receives the checking result (checking data) transmitted from the detector 12 (step S212). The received checking data is stored in a database of the storage 70. FIG. 4 illustrates a data set 100 of the obtained checking results of the checked channels. As illustrated in FIG. 4, the checking result data set 100 includes a channel name 101, a number 103 of other access points, a received-signal strength 105, and an amount 107 of noise.

Based on the other-access-points number, the beacon signal strength, and the amount of noise, the controller 50 finds a channel having optimal communication conditions, and determines this channel as one communication channel (also referred to as “second channel”) to be used by the communicator Ma 11 of the wireless communication module 10 (step S214). The communication conditions include: that the number of other access points connected to the channel is small; that the strength of the beacon signal received from each another access point is small; and that the level of detected noise is low. A channel that satisfies these communication conditions is determined as an optimal channel and set as the one communication channel. In this example, the set channel will also be referred to as “DFS channel B”. It is to be noted that a channel that satisfies at least one of the above-described communication conditions may set as the one communication channel.

Next, the controller 50 generates an instruction signal for one-minute radar signal detection (priority signal monitor) to be performed in the determined DFS channel, and transmits the instruction signal to the detector 12 (steps S214 and S216). Upon receipt of the instruction signal for one-minute radar signal detection (monitor signal), the detector 12 performs one-minute radar signal detection processing (monitoring processing) (step S218). Upon completion of the one-minute radar signal detection processing (S220), the detector 12 transmits a radar-signal-detection-processing completion signal to the controller 50 (step S222). At this time of the procedure, the DFS channel B is in a state of being switchable with the DFS channel A.

Until the communication channel used by the communicator Ma 11 of the wireless communication module 10 is switched, the controller 50 instructs the detector 12 to continue the radar signal detection processing in the DFS channel B (step S224). The instruction signal for one-minute radar signal detection is transmitted to the detector 12 (step S226). Based on the received instruction signal, the detector 12 continues radar signal detection (step S228).

Next, the controller 50 determines whether a predetermined time (predetermined time interval) has passed since the switching replacement communication channel was determined (step S230). In a case where a predetermined time has passed (Yes at step S230), the controller 50 transmits channel checking instruction information again to the detector 12 (step S202). The controller 50 may also generate an ending instruction signal to end the radar signal detection processing, and transmit the ending instruction signal to the detector 12 (step S234). Then, the detector 12 may end the radar signal detection processing (step S236). It is to be noted that the radar signal detection processing may be continued until a next checking result is obtained.

In a case where a predetermined time has not passed (No at step S230), the controller 50 determines whether the communicator Ma 11 of the wireless communication module 10 has detected a radar signal (step S232). In a case where the communicator Ma 11 has not detected a radar signal (No at step S232), the procedure returns to the processing at step S230.

In a case where the communicator 11 has detected a radar signal (Yes at step S232), the controller 50 transmits to the communicator 11 a switching instruction signal to set the DFS channel B as the communication channel to be used by the communicator 11 (step S238). The controller 50 may also generate an ending instruction signal to end the radar signal detection processing, and transmit the ending instruction signal to the detector 12 (step S234). Then, the detector 12 may end the radar signal detection processing (step S236). Thus, the communication control processing ends.

In the embodiment, all wireless communication channels that are potential DFS channels are checked in advance. This configuration ensures that an available, optimal channel can be found and utilized. The above configuration also ensures that in a case where a radar signal has been detected by the communicator 11, the current wireless communication-purpose channel is immediately switched to another wireless communication-purpose channel. With this configuration, the embodiment shortens the duration of wireless communication unavailability in a communication module.

Also in the embodiment, the checking processing is repeated at predetermined time intervals (that is, on every passage of a predetermined time interval). This configuration ensures that a communication channel optimal for a timing for switching is set.

It is to be noted that in the embodiment, the predetermined time may be infinite (that is, the checking processing may be performed for an infinite period of time). In this case, it is not necessary to repeat the checking processing at predetermined time intervals.

The communication system according to an embodiment described below is different from the communication system according to the embodiment. Specifically, the time interval for the checking processing is set based on history information indicating a history of channel switching. A description that has already been provided in the previous embodiment and that also applies in this embodiment will not be elaborated upon here.

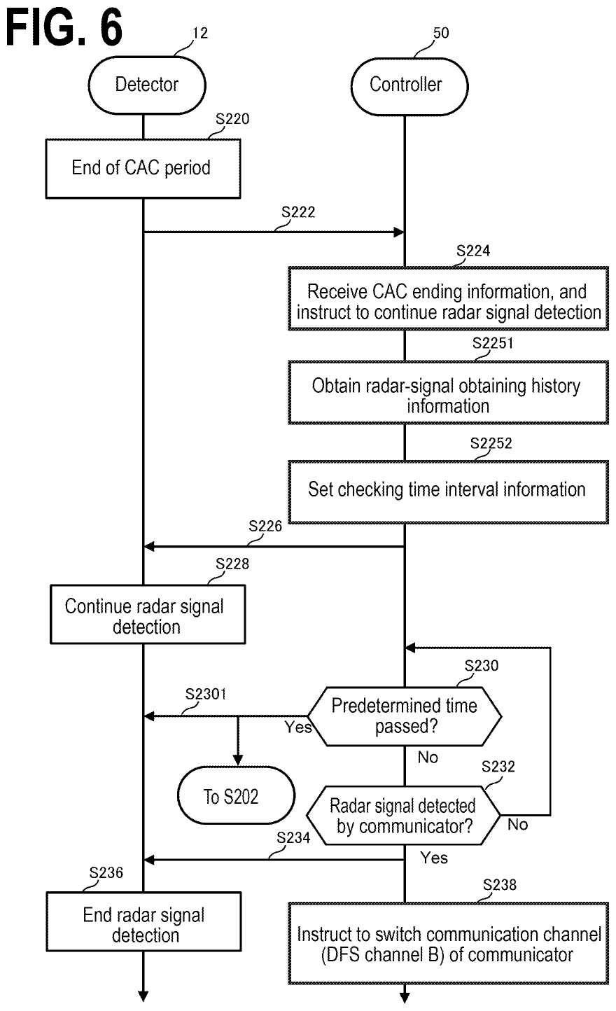

FIG. 6 is a flowchart of communication control processing according to the embodiment. The controller 50 receives ending information from the detector 12 (step S224). The ending information indicates that the CAC period for the switching replacement communication channel (the DFS channel B) has ended. Upon receipt of the ending information, the controller 50 obtains obtaining history information stored in the storage 70 (step S2251). The obtaining history information indicates a history of radar signals obtained in the DFS channel B. Based on the radar signal obtaining history information, the controller 50 updates and sets the timing for the next channel checking processing (checking time interval) (step S2252). Specifically, in a channel of low frequency of radar signal detection, the checking time interval may be elongated. Alternatively, in a channel of high frequency of radar signal detection, the checking time interval may be shortened. The controller 50 determines whether the checking time interval that has been set has passed (step S230), and transmits a channel checking instruction signal again to the detector 12 (step S226).

In the embodiment, each communication channel can be checked at an optimal time interval based on the environment in which radar signals are received. The embodiment also shortens the duration of wireless communication unavailability. The embodiment also eliminates or minimizes unnecessary checking processing. This reduces the processing load on the controller 50 and the detector 12, as well as shortening the duration of wireless communication unavailability.

The communication system according to an embodiment described below is different from the communication system according to the previous embodiment. Specifically, the following description is regarding a case where the detector of the communication system according to the embodiment is in the midst of monitoring processing (CAC) when the communicator of the communication system detects a radar signal. A description that has already been provided in the embodiment and that also applies in the embodiment will not be elaborated upon here.

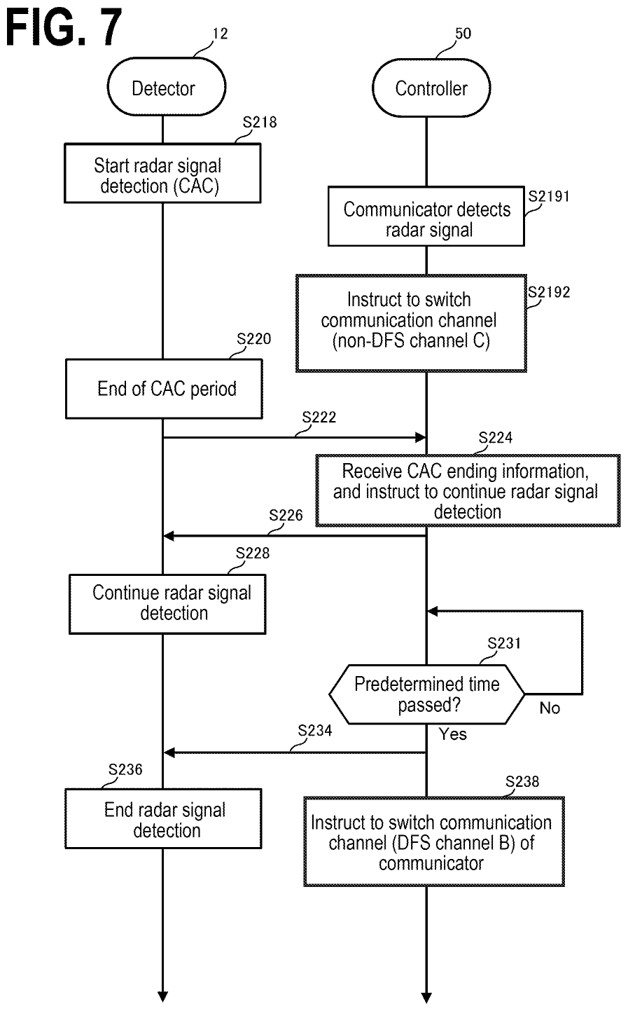

FIG. 7 is a flowchart of communication control processing according to the embodiment. As illustrated in FIG. 7, in a case where the detector 12 is in the midst of monitoring processing (in CAC mode) when the communicator 11 detects a radar signal (S2191), the controller 50 can not switch the communication channel used by the communicator 11 to a communication channel (the DFS channel B) determined based on a checking result. In this case, the controller 50 may once switch the communication channel used by the communicator 11 to a channel without a DFS (this channel may also be referred to as “third channel” or “non-DFS channel C”) (step S2192). The non-DFS channel may be any one of a W52 channel in the 5 GHz frequency range, a channel in the 2.4 GHz frequency range, or a channel in the 6 GHz frequency range.

Upon completion of the one-minute radar signal detection processing (S220), the detector 12 transmits a radar-signal-detection-processing completion signal to the controller 50 (step S222). At this time of the procedure, the DFS channel B is in a state of being switchable with the DFS channel A.

Until the communication channel used by the communicator Ma 11 of the wireless communication module 10 is switched, the controller 50 instructs the detector 12 to continue the radar signal detection processing in the DFS channel B (step S224). The instruction signal for one-minute radar signal detection is transmitted to the detector 12 (step S226). Based on the received instruction signal, the detector 12 continues radar signal detection (step S228).

The controller 50 sets switching timing, and determines whether the set switching timing has come (step S231). The switching timing may be set anytime as deemed appropriate after the end of the monitoring processing. The controller 50 waits until a predetermined timing comes (No at step S231). In a case where a predetermined timing has come (Yes at step S231), the controller 50 transmits to the communicator 11 a switching instruction signal to set the DFS channel B as the communication channel used by the communicator 11 (step S238). The controller 50 may also generate an ending instruction signal to end the radar signal detection processing, and transmit the ending instruction signal to the detector 12 (step S234). Then, the detector 12 may end the radar signal detection processing (step S236). Thus, the communication control processing ends.

With this configuration, the embodiment eliminates or minimizes communication failure, even if the communicator 11 receives a radar signal in the midst of CAC mode.

The communication system according to an embodiment described below is different from the communication system according to the embodiment. Specifically, the following description is regarding a case where a non-DFS channel is set at the time of activation of the access point. A description that has already been provided in the embodiment and that also applies in the embodiment will not be elaborated upon here.

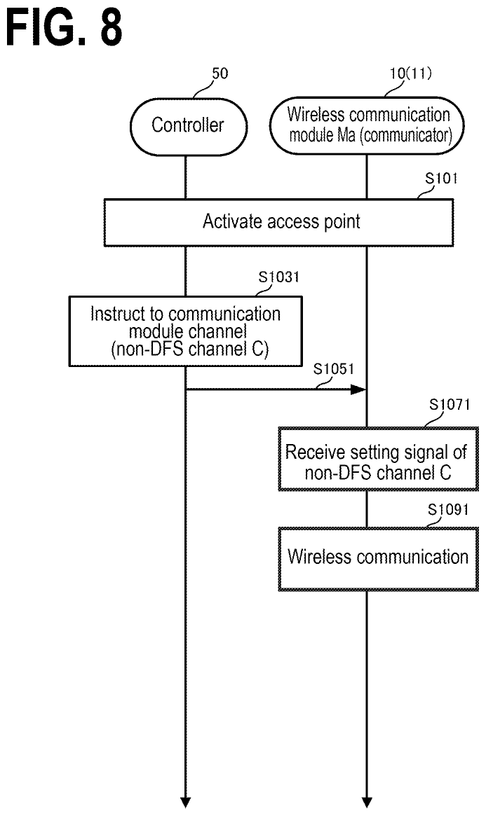

FIG. 8 is a flowchart of communication control processing according to the embodiment. In order to set a DFS channel immediately after activation of the access point 3, it is necessary to perform a CAC. Due to a CAC, wireless communication can not be established for at least one minute. In the embodiment, as illustrated in FIG. 8, the controller 50 may set a non-DFS channel (third channel) as the communication channel used by the communicator Ma 11 of the wireless communication module 10 (step S1031). The non-DFS channel may be any one of a W52 channel in the 5 GHz frequency range, a channel in the 2.4 GHz frequency range, or a channel in the 6 GHz frequency range.

The controller 50 transmits to the wireless communication module 10 a setting signal of the communication channel (non-DFS channel C) (step S1051). Upon receipt of the setting signal of the communication channel at the wireless communication module 10 (step S1071), the communicator Ma 11 of the wireless communication module 10 wirelessly communicates with the communication terminal 5 using the non-DFS channel C (step S1091). The non-DFS channel C may be switched to the DFS channel B in a manner similar to the manner described in the embodiment.

The embodiment eliminates or minimizes communication failure at the time of activation of the access point.

In the embodiment, time information is obtained before switching processing is performed to switch the non-DFS channel illustrated in the embodiments to a DFS channel.

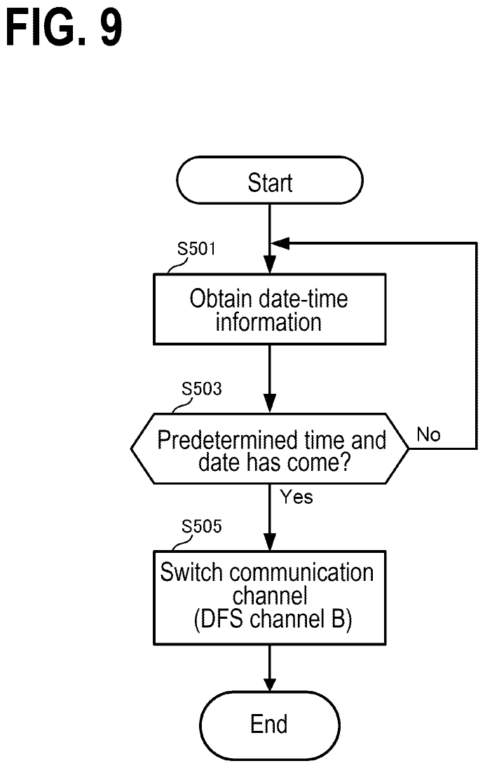

FIG. 9 is a flowchart of communication control processing according to the embodiment. As illustrated in FIG. 9, the controller 50 obtains date-time information (step S501). There is no particular limitation to the time to obtain the date-time information. The date-time information may be obtained from inside the access point 3, or may be obtained from another device. Until a predetermined time and date comes (No at step S503), the controller 50 repeats the processing at step S501. In a case where a predetermined time and date has come (Yes at step S503), the controller 50 may switch the communication channel from the non-DFS channel to the DFS channel B, which has been determined by checking processing (step S505).

In the embodiment, the communication channel is switched at a predetermined time and date. This ensures that channel switching is performed at a timing less influential to the use of the communication terminal.

It is to be noted that the embodiment may also be used to switch one DFS channel to another DFS channel.

In the embodiment, the access point includes a plurality of different wireless communication modules.

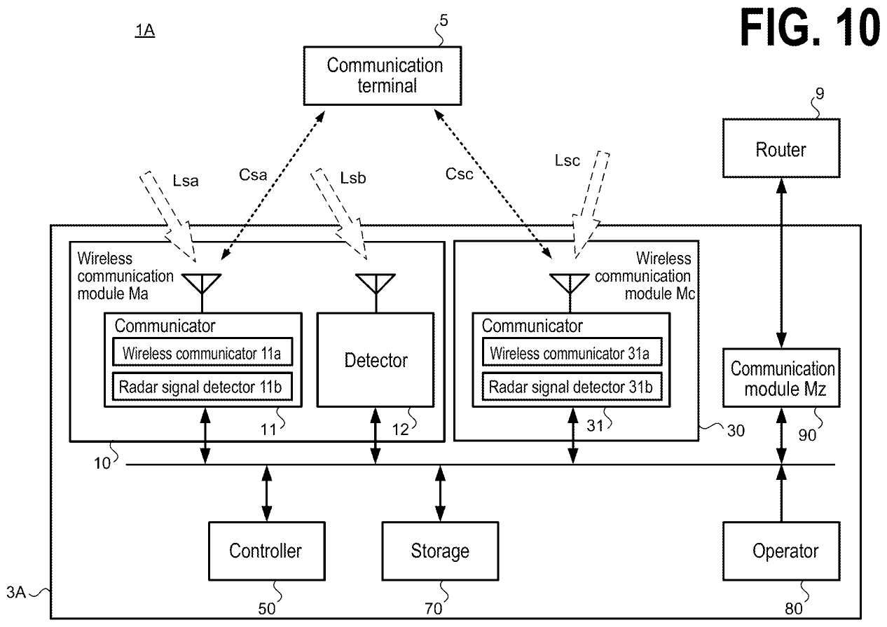

FIG. 10 is a diagram illustrating a configuration of a communication system 1A according to the embodiment of the present disclosure. As illustrated in FIG. 10, the communication system 1A includes an access point 3A in addition to the communication terminal 5 and the router 9.

The access point 3A includes a wireless communication module Mc 30 in addition to the wireless communication module Ma 10, the controller 50, the storage 70, the operator 80, and the communication module Mz 90. These elements are connected to each other via a bus. In the communication system 1A according to the embodiment, the wireless communication module Mc 30, the wireless communication module Ma 10, and the controller 50 are contained in a single enclosure to form a part of the access point 3A.

The wireless communication module Mc 30 includes a communicator 31 (also referred to as second communicator). The wireless communication module Mc 30 may be configured in the form of a single chipset different from the wireless communication module Ma 10. The communicator 31 includes a wireless communicator 31a and a radar signal detector 31b. The controller 50 sets, in the communicator 31, a channel from among channels in the 5 GHz frequency range. The wireless communicator 31a uses the channel set by the controller 50 to establish wireless communication Csc with the communication terminal 5. The radar signal detector 31b uses the same channel to detect a radar signal Lsc. The channel set in the communicator 31 is selected from the channels included in types W53 and W56 according to the IEEE 802.11 standards. It is to be noted that a channel not targeted for radar signal detection purposes may be set in the communicator 11. Examples of such channel include a channel included in type W52, a channel in the 2.4 HGz range, and a channel in the 6 GHz frequency range.

In the embodiment, in a case where the communicator 31 of the wireless communication module Mc 30 has detected a radar signal, the controller 50 may set the channel used by the communicator 31 of the wireless communication module Mc 30 using data checked by the detector 12 of the wireless communication module 10. This ensures that even though the wireless communication module Mc 30 is a wireless communication module not equipped with a detector, the wireless communication module Mc 30 is able to perform switching processing to an optimal channel. Also in the embodiment, the wireless communication module Mc 30 does not include a detector, making it less expensive than the wireless communication module Ma 10, which includes the detector 12, by an amount equal to the cost of the detector 12. Also in the embodiment, the access point includes a plurality of wireless modules. This increases the number of communication terminals connectable to the access point. With this configuration, the embodiment shortens the duration of wireless communication unavailability, preserving the communication environment while also reducing equipment costs . . . .

In the embodiment of the present disclosure, the detector generates a checking result. This configuration, however, is not intended in a limiting sense. The detector 12 and the controller 50 may cooperate to perform checking processing to generate a checking result. In this case, the detector 12 may receive data associated with each channel, and the controller 50 may perform checking processing based on the data received at the detector 12.

In the embodiment of the present disclosure, various kinds of information such as information indicating a history of radar signal detection are stored in the storage 70 of the access point 3. This configuration, however, is not intended in a limiting sense. Various kinds of information used for communication control processing may be stored in a communication device other than the access point 3, or may be stored in a storage of a server. Also in the embodiment of the present disclosure, the controller 50 may be provided outside the access point 3.

Also in the embodiment of the present disclosure, the checking result data set 100 includes the number 103 of other access points, the received-signal strength 105, the amount 107 of noise. This configuration, however, is not intended in a limiting sense. For example, the checking result data set 100 may include at least one of the number 103 of other access points, the received-signal strength 105, or the amount 107 of noise. This modification provides effects similar to the advantageous effects provided by the embodiment.

Further, the access point according to any one of the embodiments of the present disclosure may be configured as described below.

In the access point according to any one of the embodiments of the present disclosure, the controller may check each channel of the plurality of channels on every passage of a predetermined time interval to set the second channel.

In the access point according to any one of the embodiments of the present disclosure, the controller may update the predetermined time interval based on a checking result obtained in advance by checking the plurality of channels.

In the access point according to any one of the embodiments of the present disclosure, the first condition may include at least one of: a number of second communicators respectively connected to the plurality of channels excluding the first communicator; a strength of a signal transmitted from each of the second communicators to the first communicator on each of the plurality of channels; and an amount of noise detected from each of the plurality of channels.

In the access point according to any one of the embodiments of the present disclosure, in a case where the first communicator has detected the priority signal and where the detector is monitoring the second channel, the controller may switch the first channel to a third channel which enables the first communicator and the communication terminal to wirelessly communicate with each other and in which the priority signal is not detected.

In the access point according to any one of the embodiments of the present disclosure, the controller may obtain date-time information. In a case where the date-time information satisfies a second condition different from the first condition, the controller may switch the third channel to the second channel.

In the access point according to any one of the embodiments of the present disclosure, upon activation of the first communicator, the controller may switch the first channel to a third channel which is communicable with the communication terminal and in which the priority signal is not detected.

In the access point according to any one of the embodiments of the present disclosure, in a case where a second communicator different from the first communicator has detected the priority signal, the controller may set the second channel based on a checking result obtained by checking the plurality of channels and based on detection of the priority signal.

The communication controlling method according to any one of the embodiments of the present disclosure may include checking the plurality of channels on every passage of a predetermined time interval to set the second channel.

The communication controlling method according to any one of the embodiments of the present disclosure may include updating the predetermined time interval based on a checking result obtained by checking the plurality of channels obtained in advance.

In the communication controlling method according to any one of the embodiments of the present disclosure, the first condition may include at least one of: a number of second communicators respectively connected to the plurality of channels excluding the first communicator; a strength of a signal transmitted from each of the second communicators to the first communicator on each of the plurality of channels; and an amount of noise detected on each of a plurality of the first channels.

The communication controlling method according to any one of the embodiments of the present disclosure may include, in a case where the first communicator has detected the priority signal and where the detector is monitoring the second channel, switching the first channel to a third channel which enables the first communicator and the communication terminal to wirelessly communicate with each other and in which the priority signal is not detected.

The communication controlling method according to any one of the embodiments of the present disclosure may include obtaining date-time information, and in a case where the date-time information satisfies a second condition different from the first condition, switching the third channel to the second channel.

The communication controlling method according to any one of the embodiments of the present disclosure may include, upon activation of the first communicator, switching the first channel to a third channel which is communicable with the communication terminal and in which the priority signal is not detected.

The communication controlling method according to any one of the embodiments of the present disclosure may include, in a case where a second communicator different from the first communicator has detected the priority signal, setting the second channel based on a checking result obtained by checking the plurality of channels and based on detection of the priority signal.

While embodiments of the present disclosure have been described, the embodiments are intended as illustrative only and are not intended to limit the scope of the present disclosure. It will be understood that the present disclosure can be embodied in other forms without departing from the scope of the present disclosure, and that other omissions, substitutions, additions, and/or alterations can be made to the embodiments. Thus, these embodiments and modifications thereof are intended to be encompassed by the scope of the present disclosure. The scope of the present disclosure accordingly is to be defined as set forth in the appended claims.

What is claimed is:

1. An access point comprising:
a first communicator configured to wirelessly communicate with a communication terminal using a first channel among a plurality of channels;
a detector configured to detect a priority signal; and
a controller configured to:
check the plurality of channels to set a second channel from among the plurality of channels, the second channel being different from the first channel and satisfying a first condition;
instruct the detector to monitor the second channel for the priority signal; and
in a case where the first communicator has detected the priority signal in the first channel, switch the first channel to the second channel.

2. The access point according to claim 1, wherein the controller is configured to check each channel of the plurality of channels on every passage of a predetermined time interval to set the second channel.

3. The access point according to claim 2, wherein the controller is configured to update the predetermined time interval based on a checking result obtained in advance by checking the plurality of channels.

4. The access point according to claim 1, wherein the first condition includes at least one of:
a number of second communicators respectively connected to the plurality of channels excluding the first communicator;
a strength of a signal transmitted from each of the second communicators to the first communicator on each of the plurality of channels; and
an amount of noise detected from each of the plurality of channels.

5. The access point according to claim 1, wherein in a case where the first communicator has detected the priority signal and where the detector is monitoring the second channel, the controller is configured to switch the first channel to a third channel which enables the first communicator and the communication terminal to wirelessly communicate with each other and in which the priority signal is not detected.

6. The access point according to claim 5, wherein the controller is configured to:
obtain date-time information; and
in a case where the date-time information satisfies a second condition different from the first condition, switch the third channel to the second channel.

7. The access point according to claim 1, wherein upon activation of the first communicator, the controller is configured to switch the first channel to a third channel which is communicable with the communication terminal and in which the priority signal is not detected.

8. The access point according to claim 1, wherein in a case where a second communicator that is different from the first communicator has detected the priority signal, the controller is configured to set the second channel based on a checking result obtained by checking the plurality of channels and based on detection of the priority signal.

9. A computer-implemented communication controlling method comprising:
checking a plurality of channels to set a second channel, from among the plurality of channels, that satisfies a first condition and that is different from a first channel, among the plurality of channels, that is used for wireless communication between a communication terminal and a first communicator; and
instructing a detector to monitor the second channel for a priority signal; and
in a case where the first communicator has detected the priority signal in the first channel, switching the first channel to the second channel.

10. The communication controlling method according to claim 9, further comprising: checking the plurality of channels on every passage of a predetermined time interval to set the second channel.

11. The communication controlling method according to claim 10, further comprising: updating the predetermined time interval based on a checking result obtained by checking the plurality of channels obtained in advance.

12. The communication controlling method according to claim 9, wherein the first condition includes at least one of:
a number of second communicators respectively connected to the plurality of channels excluding the first communicator;
a strength of a signal transmitted from each of the second communicators to the first communicator on each of the plurality of channels; and
an amount of noise detected on each of a plurality of the first channels.

13. The communication controlling method according to claim 9, further comprising: in a case where the first communicator has detected the priority signal and where the detector is monitoring the second channel, switching the first channel to a third channel which enables the first communicator and the communication terminal to wirelessly communicate with each other and in which the priority signal is not detected.

14. The communication controlling method according to claim 13, further comprising:
obtaining date-time information; and
in a case where the date-time information satisfies a second condition different from the first condition, switching the third channel to the second channel.

15. The communication controlling method according to claim 9, further comprising: upon activation of the first communicator, switching the first channel to a third channel which is communicable with the communication terminal and in which the priority signal is not detected.

16. The communication controlling method according to claim 9, further comprising: in a case where a second communicator that is different from the first communicator has detected the priority signal, setting the second channel based on a checking result obtained by checking the plurality of channels and based on detection of the priority signal.

17. A non-transitory computer-readable recording medium storing a program which, when executed by at least one computer, causes the at least one computer to perform a method comprising:
checking a plurality of channels to set a second channel, from among the plurality of channels, that satisfies a first condition and that is different from a first channel, among the plurality of channels, that is being used for wireless communication between a communication terminal and a first communicator;
instructing a detector to monitor the second channel for a priority signal; and
in a case where the first communicator has detected the priority signal in the first channel, switching the first channel to the second channel.
